(19) United States
(12) Patent Application Publication
(10) Pub. No.: US 2006/0109899 A1
(43) Pub. Date: May 25, 2006

(54) Video data encoder employing telecine detection

(76) Inventor: Joshua Kablotsky, Sharon, MA (US)

Correspondence Address: GAUTHIER & CONNORS, LLP, 225 FRANKLIN STREET, BOSTON, MA, 02110, US

(21) Appl. No.: 10/997,575

(22) Filed: Nov. 24, 2004

(51) Int. Cl. H04N 11/04; H04N 5/253; H04N 9/47; H04N 11/02

(52) U.S. Cl. 375/240.01; 348/96

(57) ABSTRACT

A video data compression system is disclosed that includes a telecine detection unit and a reverse telecine conversion unit. In accordance with an embodiment, the telecine detection unit receives input video data and produces a telecine detection signal that is representative of whether the input video data is telecine converted video data. The reverse telecine conversion unit converts the input video data and provides reproduced cinematic data responsive to the telecine detection signal. The system also includes an encoder unit for compressing the reproduced cinematic data.

### BACKGROUND OF THE INVENTION

The present invention generally relates to video data transmission and storage systems, and relates in particular to data compression or encoding techniques for use in video data transmission and storage systems.

In video data transmission systems, there is a need to compress the video data to facilitate faster transmission of the video data. The transmitted compressed data must then be uncompressed or decoded at the receiver. In video data storage systems, the video data may be compressed prior to storage and then de-compressed when read from storage to permit less memory to be used in the storage medium as well as to provide faster writing to and reading from the storage medium.

Conventional methods for compressing video data include Motion Picture Experts Group (MPEG, MPEG-1, MPEG-2 and MPEG-4), Motion—Joint Photography Experts Group (MJPEG), Windows Media Video, H.264, On2, Quicktime, and DivX. As video data communication systems become smaller and faster, the need continues for video data compression techniques that are efficient yet provide further improved compression ratios.

### SUMMARY OF THE INVENTION

The invention provides a video data compression system that includes a telecine detection unit and a reverse telecine conversion unit. In accordance with an embodiment, the telecine detection unit receives input video data and produces a telecine detection signal that is representative of whether the input video data is telecine converted video data. The reverse telecine conversion unit converts the input video data and provides reproduced cinematic data responsive to the telecine detection signal. The system further includes an encoder unit for compressing the reproduced cinematic data in further embodiments, and the input video data may be interlaced data for providing output at 50 or 60 fields per second, while the cinematic data may be progressive data for providing an output at 24 frames per second.

### BRIEF DESCRIPTION OF THE DRAWINGS

The following description may be further understood with reference to the accompanying drawing in which:

FIG. 1 shows a diagrammatic illustrative view of a transmission system employing a video data compression system in accordance with an embodiment of the invention;

FIG. 2 shows a diagrammatic illustrative view of the encoder unit shown in FIG. 1;

FIG. 3 shows a diagrammatic illustrative view of the decoder unit shown in FIG. 1;

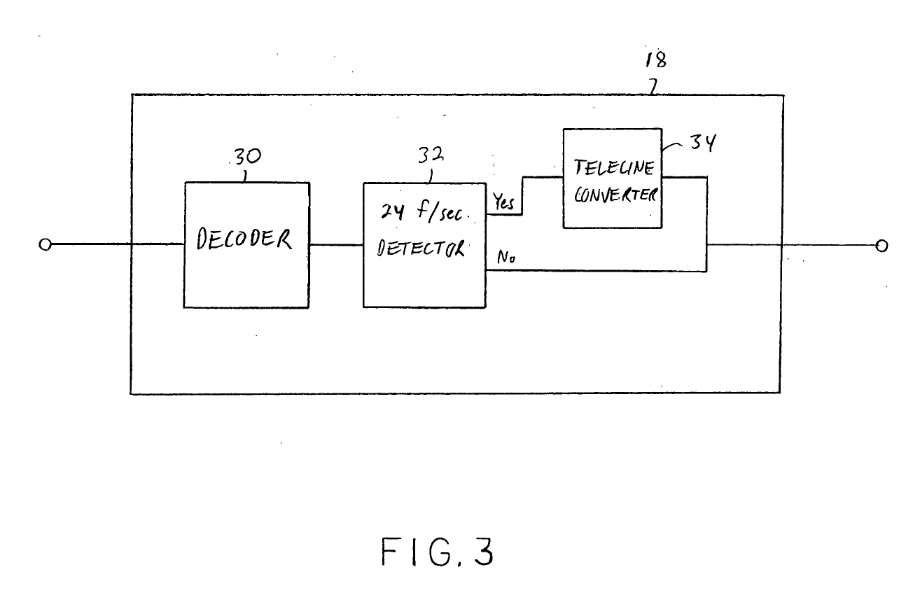

FIG. 4 shows a diagrammatic illustrative functional view of a telecine encoding and reverse telecine de-coding scheme for use in accordance with an embodiment of the invention;

FIG. 5 shows a diagramatic illustrative view of a telecine detector and reverse telecine converting system for use in accordance with an embodiment of the invention; and

FIG. 6 shows a diagramatic illustrative view of a telecine detector and reverse telecine converting system for use in accordance with another embodiment of the invention.

The drawings are shown for illustrative purposes only.

### DETAILED DESCRIPTION OF THE INVENTION

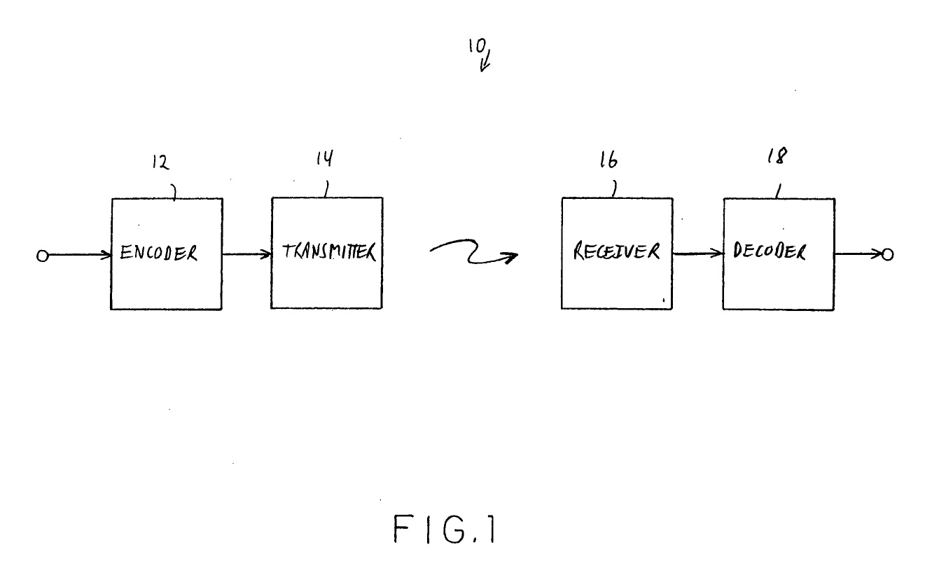

As shown in FIG. 1, a transmission system 10 employing a compression technique in accordance with an embodiment of the invention includes an encoder network 12 and a transmitter network 14 at a transmitter station, and a receiver network 16 and a decoder network 18 at a receiver station. Generally, the encoder network 12 receives an output transmission signal that is encoded and sent to the transmitter network 14 for transmission. The transmitted signal is then received by the receiver network 16 and the signal is decoded by the decoder network 18 at the receiver station.

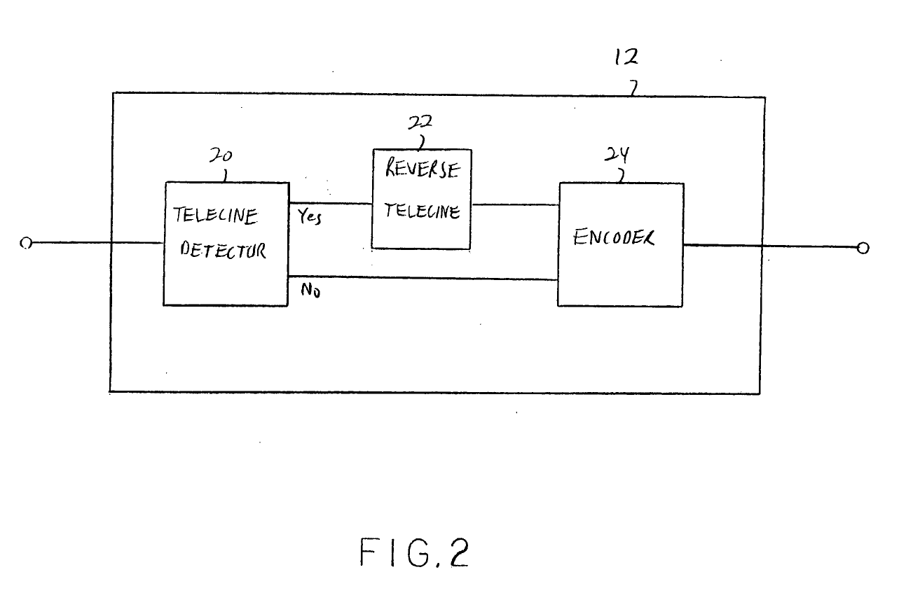

As shown in FIG. 2, the encoder network 12 may include a telecine detector unit 20, a reverse telecine unit 22 and an encoder unit 24. The telecine detector 20 determines whether the signal received by the telecine detector 20 has been converted to a telecine data signal from a progressive cinematic data signal. If not, the telecine data signal is encoded by the encoder unit 24. If the telecine data signal had been converted from a progressive cinematic data signal (such as an interlaced signal as discussed below), then the reverse telecine unit reverses the telecine data conversion process as discussed below, and reproduced cinematic data is provided by the reverse telecine unit 22 to the encoder unit 24. In the event that the signal received by the unit 22 had been a telecine converted signal (from, for example 24 frames per second progressive data to 60 fields per second interlaced data or 50 fields per second interlaced data), then significant encoding and processing (e.g., transmission and/or storage) costs may be achieved.

In a transmission system, the receiver station 18 may include a decoder unit 30, a 24 frame per second detector 32, and a telecine converter 34 as shown. If the 24 frame per second detector 32 determines that the decoded received signal is in the progressive 24 frame per second format, then the signal is converted to a telecine signal by the converter 34. In other embodiments, the transmitted signal itself may include a flag that indicates whether the received signal is in the progressive format. Such a system could also include start and end codes for the receiver station to identify the beginning and end of the 24 frame per second progressive data.

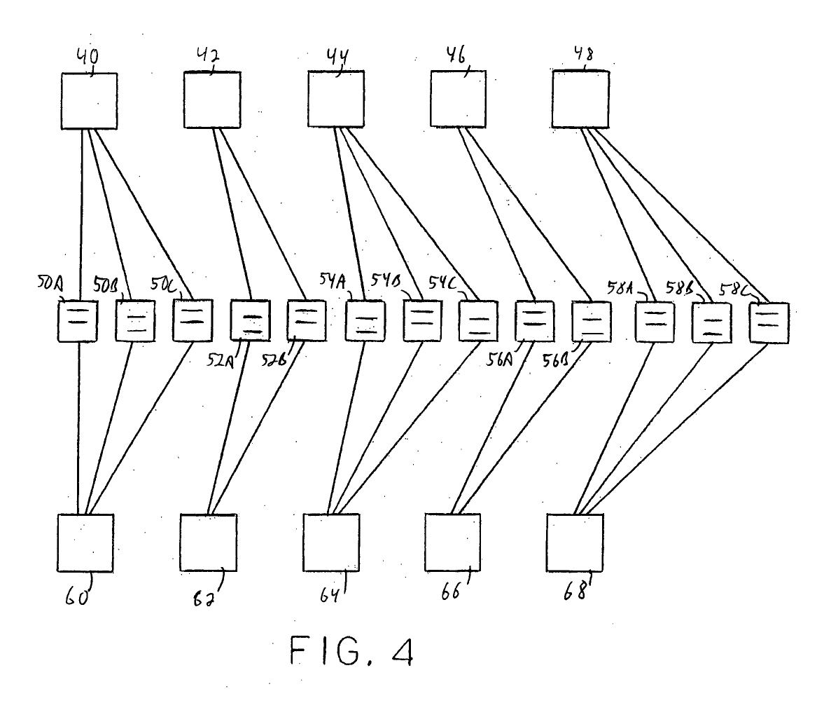

The telecince detector 20 may watch for patterns in the received signal that are indicative of the signal having been converter from progressive 24 frame per second data. For example, as shown in FIG. 4, the original 24 frames per second progressive data having frames shown at 40, 42, 44, 46 and 48 may be converted via telecine conversion to 60 fields per second interlaced video data using a conventional alternating 2-3 pull down scheme. In particular, frame 40 may be used to generate interlaced fields 50A (top), 50B (bottom) and 50C (top) and frame 42 may be used to generate interlaced fields 52A (bottom) and 52B (top). Similarly, frame 44 may be used to generate interlaced fields 54A (bottom), 54B (top) and 54C (bottom), and frame 46 may be used to generate interlaced fields 56A (top) and 56B (bottom). Frame 48 may then be used to generate interlaced fields 58A (top), 58B (bottom) and 58C (top). The process may continue in alternating 2-3 fashion to generate the 60 fields per second interlaced video data.

Once telecine detection has occurred, the reverse telecine process must identify the phase of the alternating 2-3 pattern and then reproduce the original 24 frame per second progressive data. For example, fields 50A, 50B and 50C may be identified as being from a single original frame (40) and used to generate a reproduced frame 60. In this way, the original frames 40, 42, 44, 46 and 48 may be recovered as frames 60, 62, 64, 66 and 68 as shown. Although the computational analysis involved in telecine detection and in performing the reverse telecine operation is non-trivial, the savings that will be provided by compressing, transmitting and/or storing the 24 frame per second progressive data rather than the 60 fields per second interlaced data may be substantial in certain application, possibly yielding a gain in compression ratios (e.g., 5:4) of over 50% in some applications.

The telecine detector 20 may identify whether telecine conversion has occurred through a variety of analysis techniques. For example, U.S. Pat. No. 6,408,024 discloses detection circuit that includes a one-frame delay unit and a five-frame delay unit, as well as a telecine signal detecting device that is disclosed to permit telecine detection to occur even where the input telecine video signal is not progressive due to errors in the signal or due to editing.

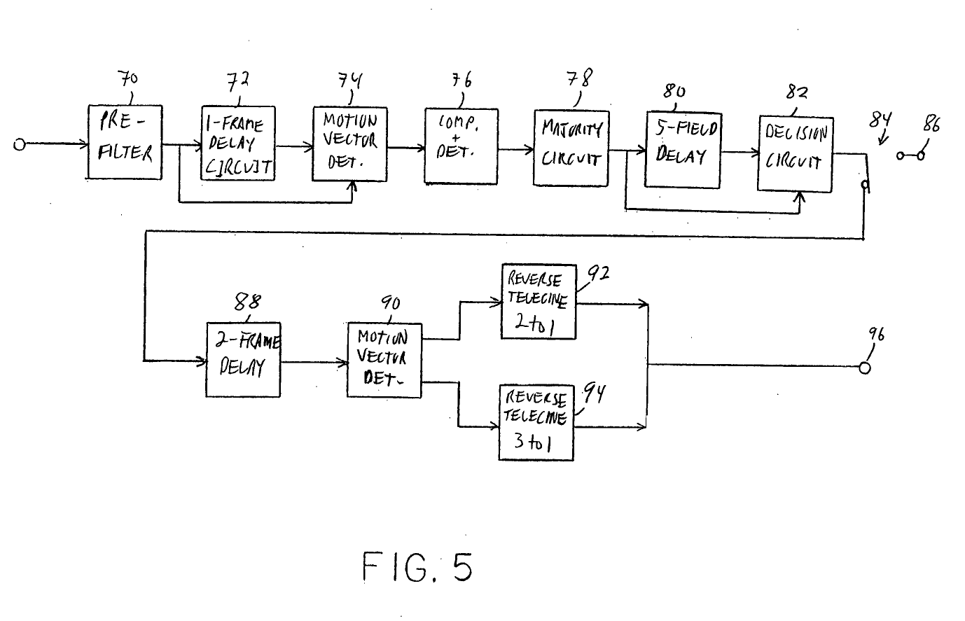

As shown in FIG. 5, a system in accordance with an embodiment of the invention may include a detector circuit, a switch 84, and reverse telecine circuit. The detector circuit includes a pre-filter circuit 70, a one-frame delay circuit 72, a motion vector detection circuit 74, a comparison and detection circuit 76, a majority circuit 78, a five-field delay circuit 80, and a decision circuit 82. The reverse telecine circuit includes a two-frame delay circuit 90, a motion vector detection circuit 92, a reverse telecine 2 to 1 circuit 94, and a reverse telecine 3 to 1 unit 96.

The pre-filter circuit 70 eliminates noise in the video signal that is received by the detector circuit. The one-frame delay circuit 72 delays the video signal by one frame (two fields) to produce a delayed video signal. The motion vector detection circuit 74 compares the delayed video signal produced by the one-frame delay circuit 72 and the present video signal for detecting a motion of video between the fields, and then produces a plurality of motion vectors. The comparison and detection circuit 76 compares the delayed video signal produced by the one-frame delay circuit 70 with a reference value. The comparison and detection circuit 76 the outputs small motion vectors that are smaller than the reference value among the motion vectors. The majority circuit 78 takes frequency distribution of the small motion vectors outputted from the comparison and detection circuit 76, detects the small motion vectors equal in size, and provides the detection result to the five-field delay circuit 80 and the decision circuit 82. The decision circuit 82 counts the number of small motion vectors that are equal in value and are not larger than the reference value. The circuit 82 then generates a decision signal representative of whether the input video signal is a telecine video signal every time a field in which the number of small motion vectors is not smaller than a predetermined value appears for every five fields.

If the signal is determined to not be a telecine converted signal, then the switch 84 is switched to node 86 to output the signal to the encoder unit 24 of FIG. 2. If the signal is determined to be a telecine converted signal, then the switch 84 is switched to direct the signal to a reverse telecine circuit that includes two-frame delay circuit 88, a motion vector detection circuit 90, a reverse telecine 2 to 1 circuit 92 and a reverse telecine 3 to 1 circuit 94. The signal is then output to the encoder unit 24 via output node 96. The two-frame delay circuit 88 and motion vector detection circuit 90 determine the phase of the telecine converted signal, and employs the reverse telecine circuits 92 and 94 alternately to perform the reverse telecine operation to obtain a recovered 24 frames per second progressive data, which is provided at node 96.

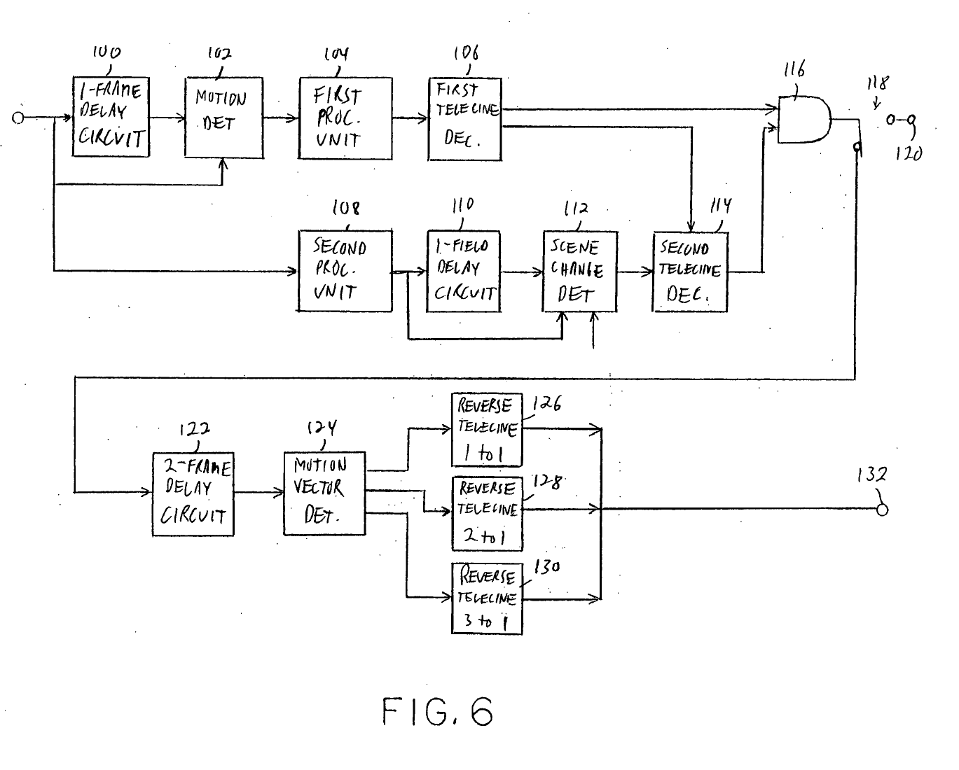

In accordance with another embodiment of the invention, a system may include a telecine detection circuit and a reverse telecine converter circuit as shown in FIG. 6. The telecine detection circuit may include a one-frame delay circuit 100, a motion detection circuit 102, a first processing unit 104, a first telecine decision circuit 106, a second processing unit 108, a one-field delay circuit 110, a scene change detector 112, a second telecince decision circuit 114 and a combiner 116. The one-frame delay circuit 100 delays an input video signal by one frame for generating a delayed video signal. The motion detector circuit 102 determines whether there is a motion between the delayed video signal and the input video signal. The first processing unit 104 accumulates the motion detection signals outputted from the motion detector 102 for one field, and generates a first statistical signal. The first telecine decision circuit 106 decides, based on the first statistical signal whether a particular field of the vide signal represents an image produced through telecine conversion to generate a first telecine decision signal, and also generates a timing signal for the second telecine decision circuit 114. The second processing unit 108 accumulates the video signals for one field for carrying out a histogram operation to generate a second statistical signal. The one-field delay circuit 110 delays the second statistical signal outputted from the second processing unit 108 by one field to generate a delayed second statistical signal. The scene change detector 112 generates, based on the second statistical signal outputted from the second processing unit 108 and the delayed second statistical signal outputted from the one-field delay unit 110, a scene change detection signal by using a predetermined threshold Cx when the video signals make a scene change. The second telecine decision circuit 114, based on the scene change signal and the timing signal outputted from the first telecine decision circuit 106, determines whether the field of the video signal represents an image produced by telecine conversion to generate a second telecine decision signal. If the first telecine decision signal and the second telecine decision signal are both indicative of the video signal being a telecine video signal, then the combiner circuit 116 provides an output telecine decision signal.

Similarly to the system of FIG. 5, if the signal is determined to not be a telecine converted signal, then the switch 118 is switched to node 120 to output the signal to the encoder unit 24 of FIG. 2. If the signal is determined to be a telecine converted signal, then the switch 118 is switched to direct the signal to a reverse telecine circuit that includes two-frame delay circuit 122, a motion vector detection circuit 124, a reverse telecine 3 to 1 circuit 126, a reverse telecine 2 to 1 circuit 128, and a reverse telecine 3 to 1 circuit 130. The signal is then output to the encoder unit 24 via output node 132. The two-frame delay circuit 122 and motion vector detection circuit 124 determine the phase of the telecine converted signal, and employs the reverse telecine circuits 126, 128 and 130 alternately to perform the reverse telecine operation to obtain a recovered 24 frames per second progressive data, which is provided at node 132.

Those skilled in the art will appreciate that numerous modifications and variations may be made to the above disclosed embodiments without departing from the spirit and scope of the invention.

What is claimed is:

1. A video data compression system comprising:
a telecine detection unit for receiving input video data and for producing a telecine detection signal that is representative of whether said input video data is telecine converted video data;
a reverse telecine conversion unit for converting said input video data and providing reproduced cinematic data responsive to said telecine detection signal; and
an encoder unit for compressing the reproduced cinematic data.

2. The video data compression system as claimed in claim 1, wherein said input video data comprises interlaced video data.

3. The video data compression system as claimed in claim 3, wherein said input video data is provided at 60 fields of data per second.

4. The video data compression system as claimed in claim 3, wherein said input video data is provided at 50 fields of data per second.

5. The video data compression system as claimed in claim 1, wherein said reproduced cinematic data is progressive data.

6. The video data compression system as claimed in claim 5, wherein said reproduced cinematic data is provided at 24 frames per second.

7. A video data compression system comprising:
a telecine detection unit for receiving interlaced video data and for producing a telecine detection signal that is representative of whether said interlaced video data is telecine converted progressive data;
a reverse telecine conversion unit for converting said interlaced video data and for providing reproduced progressive data responsive to said telecine detection signal; and
an encoder unit for compressing the reproduced progressive data and for producing encoded data.

8. The video data compression system as claimed in claim 7, wherein a format signal is transmitted to a receive station of a video data transmission system, said format signal being indicative of whether received data is 24 frames per second progressive data.

9. The video data compression system as claimed in claim 7, wherein said encoded data is stored in a memory storage unit.

10. The video data compression system as claimed in claim 7, wherein said encoded data is transmitted from a transmitter station to a receiver station.

11. The video data compression system as claimed in claim 7, wherein said receiver station includes a receiver unit and a decoder unit, and the decoder unit includes a detector for detecting whether the encoded data is representative of 24 frames per second progressive data.

12. A method of compressing video data, said method comprising the steps of:
detecting whether input video data is telecine converted video data;
providing a telecine detection signal responsive to whether the input video data is telecine converted video data; and
converting said video data to reproduced cinematic data responsive to said telecine detection signal.

13. The method as claimed in claim 12, wherein said method further includes the step of encoding said reproduced cinematic data and producing encoded cinematic data.

14. The method as claimed in claim 13, wherein said method further includes the step of transmitting said encoded cinematic data.

15. The method as claimed in claim 14, wherein said method further includes the step of detecting whether said encoded data is representative of 24 frames per second progressive data.

16. The method as claimed in claim 13, wherein said method further includes the step of storing said encoded cinematic data in a memory storage unit.
